(19) United States
(12) Patent Application Publication
(10) Pub. No.: US 2003/0213525 A1
(43) Pub. Date: Nov. 20, 2003

(54) Insulative support apparatus

(76) Inventors: Kartik A. Patel, Chapel Hill, NC (US); Holger Wilhelm Johann, Chapel Hill, NC (US); Charles M. Princell, Hickory, NC (US)

Correspondence Address: Womble Carlyle Sandridge & Rice, PLLC, P.O. Box 7037, Atlanta, GA, 30357-0037, US

(21) Appl. No.: 10/150,259

(22) Filed: May 17, 2002

(51) Int. Cl. F16L 9/14

(52) U.S. Cl. 138/149; 138/151; 138/156

(57) ABSTRACT

Disclosed is an insulative support member typically for insulating piping. The insulative support member provides a supportive point of attachment for a hanger to attach the insulated pipe to a ceiling. The support member can provide both insulative value and structural support whereby a hanger can attach to the piping insulation without crushing the insulation.

### FIELD OF THE INVENTION

The present invention generally relates to an insulative system and more specifically to a system for providing insulative support in a piping system.

### BACKGROUND

Pipe insulation is used to transport fluid that is either hotter or colder than the ambient environment. Typically, the insulation commonly used for residential, commercial and light industrial pipe is made from either fiberglass or foamed polymers. Pipes are usually insulated with cylindrical insulation and then wrapped with tape or fabric in such a manner that individual lengths form clam shells around a hinge of tape or fabric. Pipe insulation normally comes in three-foot lengths having two semi-cylindrical pieces provided with a pressure-sensitive adhesive so that when the two cylindrical halves are placed around a pipe and brought together, the halves can be adhesively connected to each other. Additionally, the abutting ends of three foot cylindrical pieces can be connected together with a circumferentially wrapped piece of adhesive tape to provide virtually continuous insulation.

Insulation made from either foamed polymers or fiberglass is often provided in predetermined lengths of half-cylinders and is installed around pipes by placing the two half-cylinders together around the pipe and holding them in place with wires or adhesives after which they are wrapped in tape, canvas, paper, foil or other material to hold them firmly in place.

Long horizontal runs of pipes are supported with hangers that are usually in the form of metal strips suspended from beams. The metal strips may be bent to conform with the circumference of the insulation around the pipe being supported upon which the insulated pipe is placed. Hangers are normally spaced between 10 and 15 feet apart to support long runs of pipe.

Normally, the practice in the industry is to insulate the entire length of the pipe and place a hanger on the outside in contact with the insulation. Consequently, the insulation itself acts as a structural member in supporting the pipe. The portions of the hangers contacting the insulation normally are of relatively narrow width, resulting in large stress concentrations over a small area of the insulation. Since thermal pipe insulation is by nature porous and fragile, the concentration of pressures over a relatively small area frequently crushes the insulation. In time, often aided by vibration or jarring of the pipe, the crushed area continues to deteriorate, forming not only an unsightly appearance but, more seriously, materially reducing the desired insulating effect.

Pipe supports are frequently used to avoid damage to the insulation where it is supported on a hanger. Some pipe supports are semi-cylindrical pieces of metal that are usually approximately nine inches long. They are placed beneath the insulated pipe where it contacts the hanger. Pipe support devices having an inside diameter approximately equal to the outside diameter of the pipe spread the weight of the supported, insulated pipe over a greater area to diminish crushing or deterioration of the insulation. Unfortunately, such supports are difficult to install and at best they diminish the destruction of the insulation or its insulative value but not completely eliminate it.

### SUMMARY

The present invention provides an insulative support member which is useful for insulating piping. The insulative support member provides a supportive point of attachment for a hanger to attach the insulated pipe to a ceiling. The support member can provide both insulative value and an attachment point having compressive strength whereby a hanger can attach to the piping insulation without crushing the insulation.

In greater detail, the insulative support member comprises a first material having a compressive strength from about 80 to 120 psi and a density from about 7 to 15 lb/ft³ and a second material in communication with the first material and the second material having a compressive strength from about 2 to 8 psi and a density from about 2 to 5 lb/ft³. Typically, the first material comprises a foamed glass and the second material comprises a foamed polymer. Furthermore, the supportive member comprises a first and second half shaped to fit the exterior of a pipe. The first and second half each comprise a midsection formed from the first material and end sections formed from the second material.

An additional embodiment includes an insulative support member comprising a bottom section having at least one foamed polymeric region and a foamed ceramic region and a top section having at least one foamed polymeric region and a foamed ceramic region. The foamed ceramic region of the top section is operatively aligned with the foamed ceramic region of the bottom section with an adhesive connecting the top section to the bottom section. Additionally, the insulative support member includes a top and bottom section each comprising a channel running the length of the section.

Furthermore, a method of forming an insulative support member is included. The method provides a section of a first material having a compressive strength from about 80 to 120 psi and a density from about 7 to 15 lb/ft³ and combining a section of a second material having a compressive strength from about 2 to 8 psi and a density from about 2 to 5 lb/ft³ with the section of the first material. Additionally, the method includes forming a channel within the combined sections of the first and second material sections.

### DESCRIPTION OF THE DRAWINGS

In the drawings:

FIG. 1 is a cross-sectional view of the insulative support member;

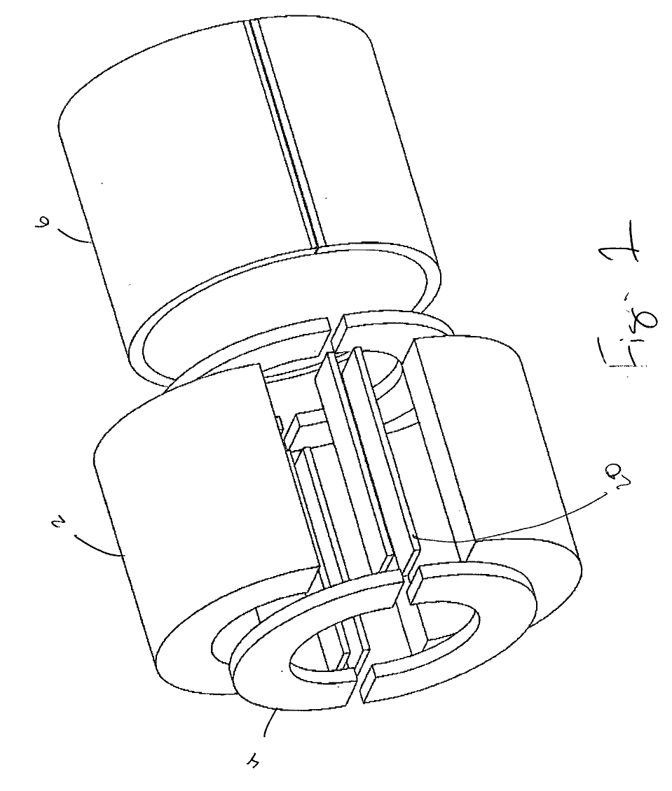

FIG. 2 is a further cross-sectional view of the insulative support member; and

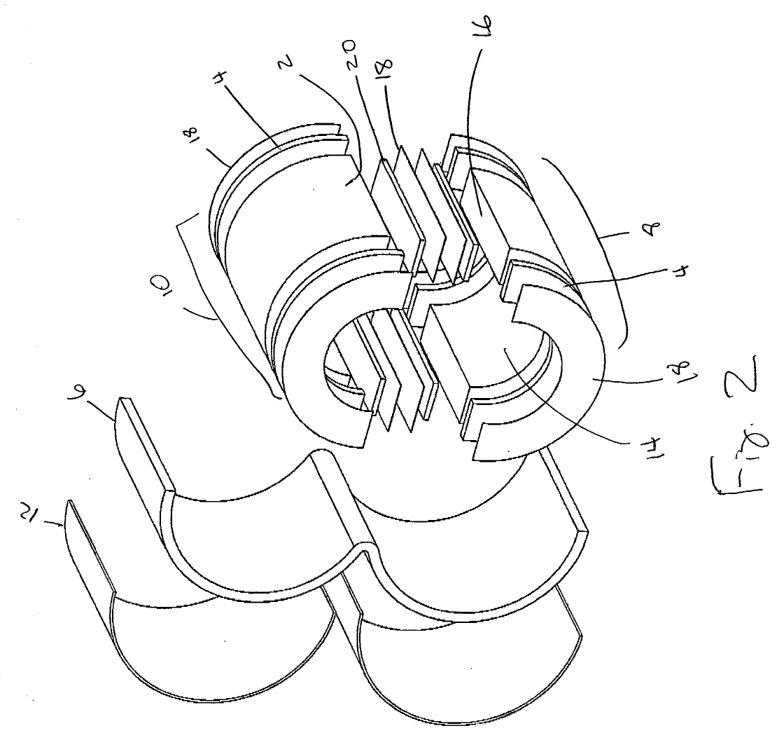

FIG. 3 is a view showing the rigid cladding.

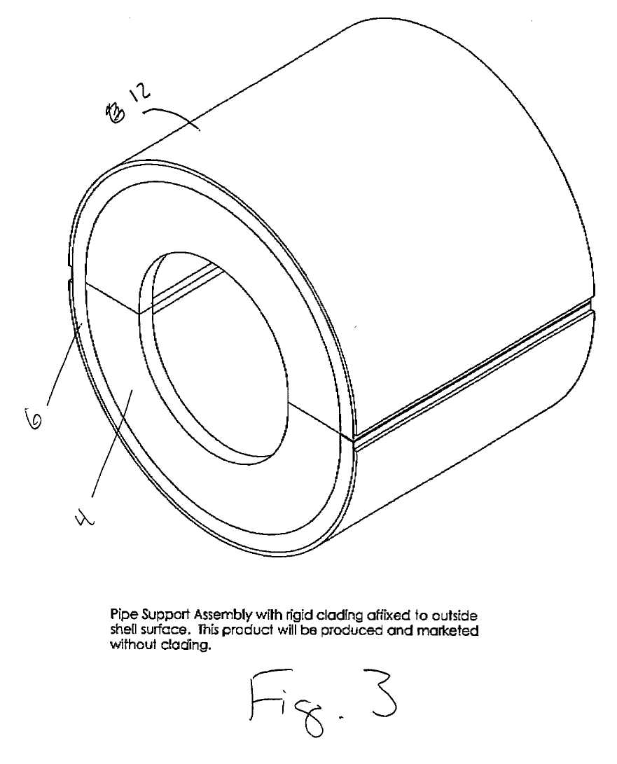

### DETAILED DESCRIPTION

The present invention provides an insulative support member typically for use in the insulation of pipe. The support member comprises at least two separate materials having different densities and compressive strengths. The material having the greater compressive strength is the attachment point for a hanger supporting the insulated piping to the ceiling above. The material having the greater compressive strength also provides both insulative values and strength to resist the compressive forces of the ceiling hangers supporting the insulated pipes.

In greater detail, the insulative support member comprises a first material 2 having a compressive strength from about 80 to 120 psi and a density from about 7 to 15 lb/ft³ and a second material 4 in communication with the first material and the second material having a compressive strength from about 2 to 8 psi and a density from about 2 to 5 lb/ft³. Typically, the first material comprises a foamed glass or ceramic and the second material comprises a foamed polymer.

The insulative support apparatus may comprise a first bottom half 8 and a second top half 10 formed to fit the exterior of a pipe in a clam shell formation. The two halves may have any dimensions and may or may not be halves of equal dimension. The two halves of the insulative support apparatus are formed to fit both the top and bottom exterior of a pipe. The pipe may have any exterior configuration. Typically, pipes are circular and the two halves of the support apparatus have a channel 14 running the length of the half. The channel is designed such that the exterior of the pipe can rest within the channel, thus when the two halves of the support apparatus are brought together, the pipe rests within the channel and is encased by the support apparatus.

The two halves of the support apparatus may be joined by an adhesive. The adhesive may be applied to the longitudinal joint 16 where the two halves are joined when the pipe is encased by the support apparatus. The adhesive may be pre-applied to the longitudinal joint and may have a release paper 18 applied to the adhesive. Furthermore, the two halves may be joined by a hinge 6. The hinge 6 may be in the form of a tape applied to the two halves. Additionally, cloth, paper or foil can be used to join the two halves together.

Furthermore, the two halves may have a substantially rigid cladding 12. For example, the substantially rigid cladding 12 may comprise a polymeric or metal sheeting. Typically, the cladding 12 is affixed to the outer hinge joining the two halves of the support apparatus.

In an added embodiment, the insulative support member comprises a bottom section 8 having at least one foamed polymeric region 4 and a foamed ceramic region 2 and a top section 10 having at least one foamed polymeric region 4 and a foamed ceramic region 2. The foamed ceramic region of the top section is operatively aligned with the foamed ceramic region of the bottom section with a hinge connecting the top section to the bottom section. Additionally, the insulative support member includes a top and bottom section each comprising a channel 14 running the length of the section. The top section may also have an adhesive.

The thermal conductivity of the insulative support member may be less than about 0.30 BTU-in/hr ft²° F. at 75° F. when measured according to ASTM C 335. The water vapor transmission (WVT) of the insulative support member may be less than about 0.10 perm-in when tested according to ASTM E 96, procedure A. The adhesive pads or tape 20 are further described in a co pending provisional application filed May 17, 2002 having the title of Composite Hot-Melt Pressure Sensitive Adhesive Insulation Joining Construction, Ser. No. ______ which is incorporated herein by reference in its entirety.

In a further embodiment, the insulative support member may comprise foamed polymeric adhesive pads 20 for joining the first 8 and second 10 halves of the insulative support member. The adhesive pads 20 may also comprise a release paper 18. The adhesive pads 20 may comprise a foamed polymer as described herein, and the adhesive may be an adhesive such as adhesives. Adhesives may be dispersed in a volatile organic solvent. Adhesives may be any of, but not limited to, the neoprene based, rubber-based, or elastomeric types, such as Armaflex 520 Adhesive.

Furthermore, a method of forming an insulative support member is described. The method includes providing a section of a first material having a compressive strength from about 80 to 120 psi and a density from about 7 to 15 lb/ft³ and combining a section of a second material having a compressive strength from about 2 to 8 psi and a density from about 2 to 5 lb/ft³ with the section of the first material. Additionally, the method includes forming a channel within the combined sections of the first and second material sections.

Foamed Polymer

The foamed polymeric region may comprise a foamed polymer comprising a vinyl nitrile foam. Typically, the vinyl nitrile foam insulation will be extruded in a tubular configuration and longitudinally slit. More generally, any conventional foamed insulation sleeve material of nitrile polymers including ABS (acrylonitrile-butadiene-styrene), thermoplastic elastomers (which are usually block copolymers of polystyrene and an elastomer such as polyisoprene, polybutadiene, ethylene-propylene, rubber or ethylene-butylene rubber), polyethylene, polypropylene, ethylene-propylene (EP) rubber, polystyrene, polyvinyl chloride (PVC), polyether, polyurethane or polyester may be used. Furthermore, the foamed polymer may comprise a foamed polyurethane, polyurethane modified polyisocyanurate, polyisocyanurate, phenol-formaldehyde, polystyrene, polyvinyl chloride, polyethylene and polypropylenepolystyrene.

Furthermore, the foamed polymeric may comprise an elastomeric foam, such as a closed cell foam made from a natural or synthetic rubber or a mixture of the two, and containing other polymers, other chemicals or both, which may be modified by organic or inorganic additives. These foams have properties similar to those of vulcanized rubber, namely the ability to convert from thermoplastic to a thermosetting state by cross-linking (vulcanization) and the ability to recover substantially its original state when strained or elongated.

Additionally, the foamed polymeric may comprise a polyolefin foam, such as a closed cell foam made from polymers made by the polymerization of olefins, such as ethylene or propylene or copolymerization of olefins with other monomers. The polymers may be expanded hydrochlorofluorocarbons, hydrofluorocarbons, hydrocarbons, chemical blowing agents, atmospheric gases, or a combination thereof.

Foamed Ceramic

One example of a suitable cellular ceramic material for the cellular ceramic segments is cellular glass formed by mixing pulverulent glass particles with a cellulating agent and forming a cellulatable glass batch as described in U.S. Pat. No. 3,354,024. The formulated glass may comprise, for example, conventional borosilicate or soda lime glass in crushed cullet form and the cellulating agent may comprise a carbonaceous material such as carbon black and the like. Other suitable cellular ceramic materials formed of a cellulatable siliceous composition are disclosed in U.S. Pat. No. 3,441,396, which is incorporated herein by reference.

The cellulatable glass batch is placed in a mold as, for example, a substantially rectangular mold. The cellulatable glass batch is then heated to cellulating temperature. At such temperature, the formulated glass particles soften and coalesce and the cellulating agent reacts to generate a gas and form individual closed cells within the block of cellular glass.

Adhesives

In choosing a bonding agent for adhesively securing the sections, it is preferred that the bonding agent will not melt or flow at the intended operating temperature or temperatures to which the insulating body will be subjected. Flowable adhesives such as hot asphalt may be used in cases where the entire adhesive bulk will not reach melt or flow temperatures, leaving sufficient unmelted adhesive to maintain physical integrity. The bonding agent chosen should retain sufficient strength yet remain flexible at operating conditions. It is desirable that the hardness of the bonding agent on the Shore A scale should be below 60 at 75° F. and preferably below 45. The bonding agent should be compatible with the cellular ceramic material. The bonding agent should be high in solid content, such content desirably being about 90% by weight with 95% by weight or higher preferred. The bonding agent may be chemically setting, that is, the bonding agent be internally cured by reaction of two or more components. It is further desirable that the bonding agent be able to set rapidly to facilitate handling of the insulating body of the invention. A catalyst may be used to accelerate the setting time of certain bonding agents, as is known to those in the art.

Examples of suitable bonding agents are urethanes, silicones, or various epoxy adhesives. Certain silicone adhesives may be used where combustibility of the adhesive is objectionable or where stress corrosion of stainless steel could be a problem. Hot melt adhesives may also be used as a bonding agent up to temperatures where they will not flow or lose their strength. If hot melt adhesives are employed, such as asphalt, coal tar or other bitumens, application should be limited to temperatures that are at least about 50° F. below the respective softening point of the hot melt adhesive within the majority of the adhesive bulk.

It will be understood by those skilled in the art that while the present invention has been disclosed above with reference to preferred embodiments, various modifications, changes and additions can be made to the foregoing invention, without departing from the spirit and scope thereof.

In the claims:

1. An insulative support member comprising:
a first material having a compressive strength from about 80 to 120 psi and a density from about 7 to 15 lb/ft³; and
a second material in communication with the first material and the second material having a compressive strength from about 2 to 8 psi and a density from about 2 to 5 lb/ft³.

2. The insulative support member of claim 1, further comprising an adhesive.

3. The insulative support member of claim 1, wherein the second material comprises a foamed polymer.

4. The insulative support member of claim 1, further comprising a first half and a second half, wherein each half is shaped to fit an exterior of a pipe.

5. The insulative support member of claim 1, wherein a thermal conductivity of the insulative support member is less than about 0.30 BTU-in/hr ft² ° F. at 75° F. when measured according to ASTM C 335 and a water vapor transmission (WVT) of the insulative support member is less than about 0.10 perm-in when tested according to ASTM E 96, procedure A.

6. The insulative support member of claim 4, wherein the first and second half each comprise a midsection formed from the first material and an end section in communication with the midsection and the end section formed from the second material.

7. The insulative support member of claim 4, wherein the first half and the second half each have a longitudinal joining section and wherein the longitudinal joining section comprises an adhesive.

8. The insulative support member of claim 7, wherein the adhesive is selected from the group consisting of urethanes, silicons, epoxy adhesives and combinations thereof.

9. The insulative support member of claim 4, wherein the first half and second half are bonded together.

10. The insulative support member of claim 4, further comprising a hinge connecting the first and second half together.

11. The insulative support member of claim 1, wherein the first material comprises a foamed glass.

12. The insulative support member of claim 1, further including a rigid cladding.

13. An insulative support member comprising:
a bottom section having at least one foamed polymeric region and a foamed ceramic region; and
a top section having at least one foamed polymeric region and a foamed ceramic region and wherein the foamed ceramic region of the top section is operatively aligned with the foamed ceramic region of the bottom section.

14. The insulative support member of claim 11, wherein a thermal conductivity of the insulative support member is less than about 0.30 BTU-in/hr ft² ° F. at 75° F. when measured according to ASTM C 335 and a water vapor transmission (WVT) of the insulative support member is less than about 0.10 perm-in when tested according to ASTM E 96, procedure A.

15. The insulative support member of claim 13, further including an adhesive.

16. The insulative support member of claim 15, wherein the top section and the bottom section each have a longitudinal joining section and wherein the longitudinal joining section comprises the adhesive.

17. The insulative support member of claim 13, wherein the foamed polymer region has a compressive strength from about 80 to 120 psi and a density from about 7 to 15 lb/ft³ and the foamed ceramic region has a compressive strength from about 2 to 8 psi and a density from about 2 to 5 lb/ft³.

18. The insulative support member of claim 13, wherein the top and bottom section each comprise a channel running the length of the section.

19. The insulative support member of claim 15, wherein the top section comprises an adhesive.

20. An insulative support member comprising:
a first material having a compressive strength from about 80 to 120 psi and a density from about 7 to 15 lb/ft³;
a second material having a compressive strength from about 2 to 8 psi and a density from about 2 to 5 lb/ft³; and
a channel running the length of the insulative support member.

21. A method of forming an insulative support member comprising:
providing a section of a first material having a compressive strength from about 80 to 120 psi and a density from about 7 to 15 lb/ft³;
combining a section of a second material having a compressive strength from about 2 to 8 psi and a density from about 2 to 5 lb/ft³ with the section of the first material; and
forming a channel within the combined sections of the first and second material sections.

22. The insulative support member of claim 21, wherein a thermal conductivity of the insulative support member is less than about 0.30 BTU-in/hr ft² ° F. at 75° F. when measured according to ASTM C 335 and a water vapor transmission (WVT) of the insulative support member is less than about 0.10 perm-in when tested according to ASTM E 96, procedure A.

23. The method of claim 21, wherein the first material comprises a foamed glass.

24. The method of claim 21, wherein the second material comprises a foamed polymer.

25. The method of claim 21, wherein the channel is formed to fit the exterior of a pipe.
